(19) United States
(12) Patent Application Publication
(10) Pub. No.: US 2009/0275316 A1
(43) Pub. Date: Nov. 5, 2009

(54) Minimal Distraction Capture of Spoken Contact Information

(75) Inventor: Stephen R. Springer, Needham, MA (US)

Correspondence Address: Sunstein Kann Murphy & Timbers LLP, 125 SUMMER STREET, BOSTON, MA, 02110-1618, US

(73) Assignee: NUANCE COMMUNICATIONS, INC., Burlington, MA (US)

(21) Appl. No.: 12/434,696

(22) Filed: May 4, 2009

Related U.S. Application Data
(60) Provisional application No. 61/050,281, filed on May 5, 2008.

(51) Int. Cl. H04M 3/42; G10L 17/00

(52) U.S. Cl. 455/415; 704/246; 704/E17.001

(57) ABSTRACT

Real-time automatic capturing and storing is described for contact information such as a telephone number or other well-structured contact information spoken during a conversation over the mobile telephone. A user input is received to capture contact information contained in recent audio data processed by the mobile device. Speech in the recent audio data is identified that corresponds to the contact information. Then speech recognition is used to extract the contact information from the identified speech. The contact information is stored in mobile device memory storage.

### CROSS-REFERENCE TO RELATED APPLICATIONS

This application claims priority from U.S. Provisional Patent Application No. 61/050,281 filed on May 5, 2008, the disclosure if which is incorporated herein in its entirety.

### FIELD OF THE INVENTION

This application relates to mobile telephone communication systems. In particular, it relates to methods of real-time extraction and storing the information received from the voice channel and temporarily saved on a mobile telephone as an audio-buffering record.

### BACKGROUND ART

In the last decade, mobile networking has become a mature technology coalescing various capabilities ranging from wireless telephony to basic computing and internet connection. The heart of such networking remains a mobile phone conventionally processing voice signals. However, mobile phone capabilities of mobile networking remain limited. In particular, mobile phones have not been adapted to support a real-time memo function. As a result, a mobile-phone user receiving, for example, a telephone number from a transmitting party during a phone conversation, has to interrupt the flow of the conversation to be able to write down the number spoken to him, or memorize it.

Phone numbers are likely the single most common datum shared over the phone, very often in a situation when the user is distracted attending to other parallel tasks. The necessity to use both hands and eyes to find a pen and paper to record the spoken telephone number in a situation such as driving can be life-threatening. However, the urge to do so is frequent, as the whole purpose of using a mobile phone while driving is communication, and the spoken number is necessary for further communication. A real time capture of the telephone number within such context can be considered critical because otherwise the information is lost.

Kim, in U.S. Pat. No. 6,421,353, which is incorporated herein in its entirety, suggested a particular implementation of a mobile radio phone capable of general recoding and reproducing data received from a voice channel. However, the problem of real-time automatic extraction and recording of the telephone number transmitted from a communicating party without interruption of the phone conversation remains largely unsolved.

### SUMMARY OF THE INVENTION

Embodiments of the present invention use speech recognition to realize a real-time memo function on a mobile phone or other mobile device for capturing and storing contact information such as a telephone number in recently processed audio data. A user input is received at a mobile device to capture contact information contained in recent audio data processed by the mobile device. Based on the received user input, speech in the recent audio data is identified that corresponds to the contact information. Then speech recognition program is used in a processor to extract the contact information from the identified speech. The contact information is stored in mobile device memory storage.

Embodiments of the present invention also include a mobile device for wireless networking. An audio buffer buffers recent audio data to be processed by the mobile device. A user input element receives a user input from a user to process the recent audio data buffered on the audio buffer. A device processor uses a speech recognition program for: (i.) identifying speech data in the recent audio data that corresponds to spoken contact information, (ii.) extracting the spoken contact information from the speech data, and (iii.) storing the contact information in a memory storage.

Embodiments of the present invention also include a computer program product for capturing contact information on a mobile device. The computer program product includes a tangible storage medium having a computer readable program code thereon. The computer program product includes program code for receiving a user input to capture contact information contained in recent audio data processed by the mobile device, program code for identifying speech in the recent audio data corresponding to the contact information, program code for using speech recognition to extract the contact information from the identified speech, and program code for storing the contact information in a mobile device memory storage.

In further specific embodiments, the extracted contact information is provided to the user and a confirmation input is received from the user that the contact information has been correctly extracted. For example, the extracted contact information may be audibly and/or visually provided to the user for confirmation. The extracted contact information also may be provided to the user in response to a confirmation request input from the user. The user input may be received from a hardware button on the mobile device or a programmable user input element on the mobile device.

In some specific embodiments, extracting the contact information may include outputting to the user a success tone indicating that the contact information has been confidently extracted; for example, when an extraction confidence level exceeds a confidence threshold value. Extracting the contact information also may include outputting to the user a warning tone indicating that the contact information may not have been successfully extracted; for example, when an extraction confidence level fails to reach a confidence threshold value.

The contact information may specifically include a telephone number. And the telephone number may be dialed in response to a dialing request from the user.

### BRIEF DESCRIPTION OF THE DRAWINGS

The embodiments of the present invention will become more apparent by referring to the following detailed description of the invention and the attached drawings in which:

FIG. 1 shows various functional blocks on the side of the user of a mobile device according to one embodiment of the present invention.

FIG. 2 shows an operational flow-chart of real-time extraction of and storing the spoken telephone number according to an embodiment of the present invention.

FIG. 3 provides illustrates performance of a mobile device during the real-time extraction of and storing the spoken telephone number depicted in FIG. 2.

### DETAILED DESCRIPTION OF SPECIFIC EMBODIMENTS

Various embodiments of the present invention are directed to techniques for real-time extraction and storing contact information such as a telephone number, spoken over the mobile device by the transmitting party to the user and temporarily stored as an audio-buffering record on the mobile device. For the purposes of this disclosure and accompanying claims, real-time performance of a system is understood as performance which is subject to operational deadlines from a given event to a system's response to that event. For example, a real-time extraction of contact information (such as a telephone number, an address, or an e-mail address) from an audio buffer of a mobile device may be one triggered by the user and executed simultaneously with and without interruption of a mobile communication during which such telephone number has been recorded. Although the description of specific embodiments of the invention is provided for extraction of a telephone number, it is understood that the telephone number is used only as an example, and real-time extraction of any other pre-determined type of information stored on a mobile device is within the scope of the invention.

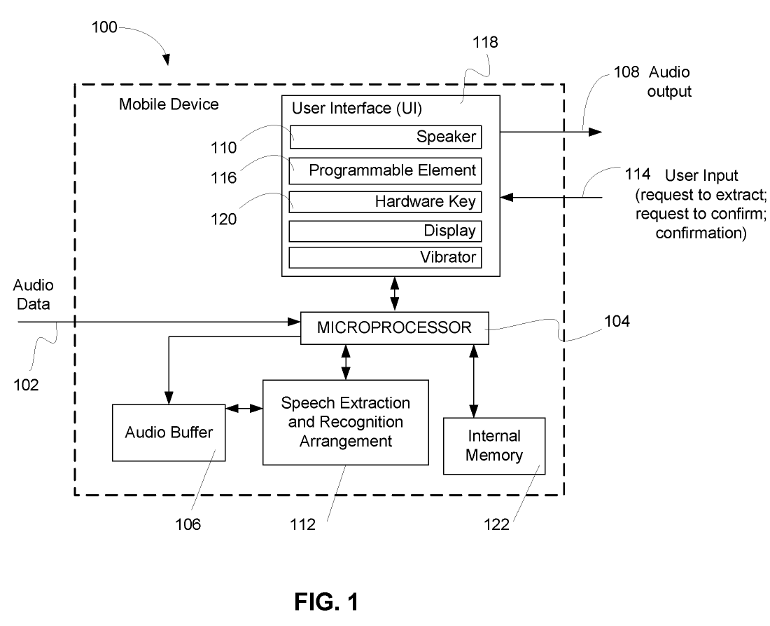

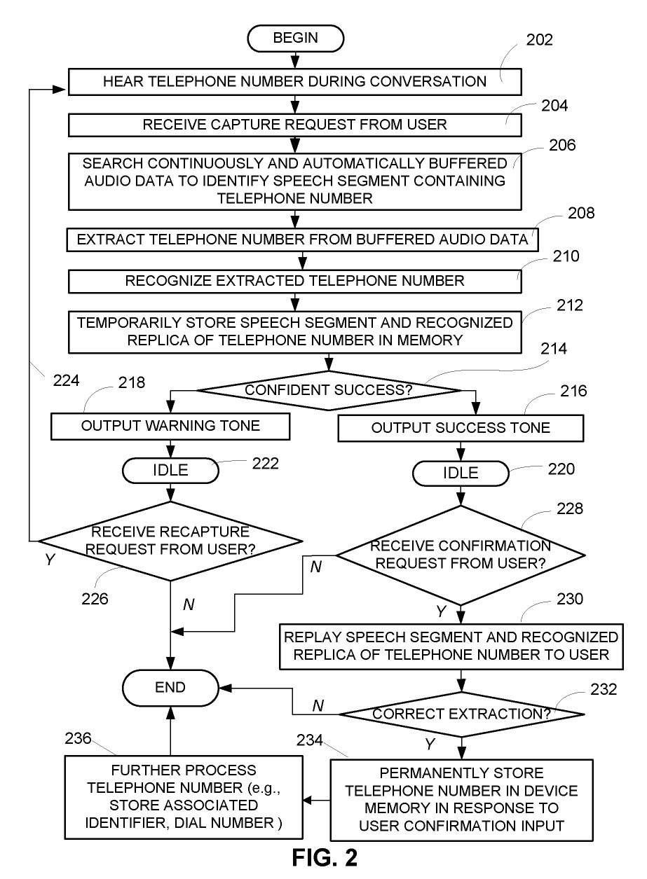

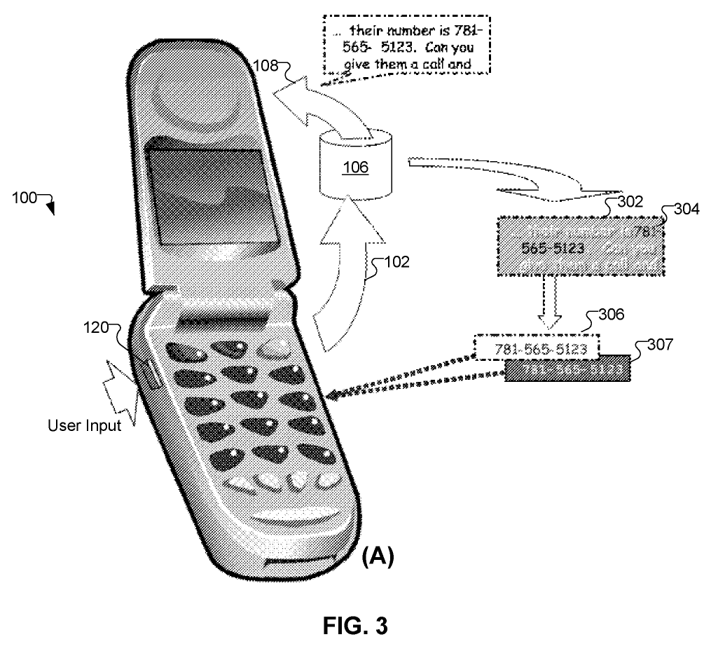

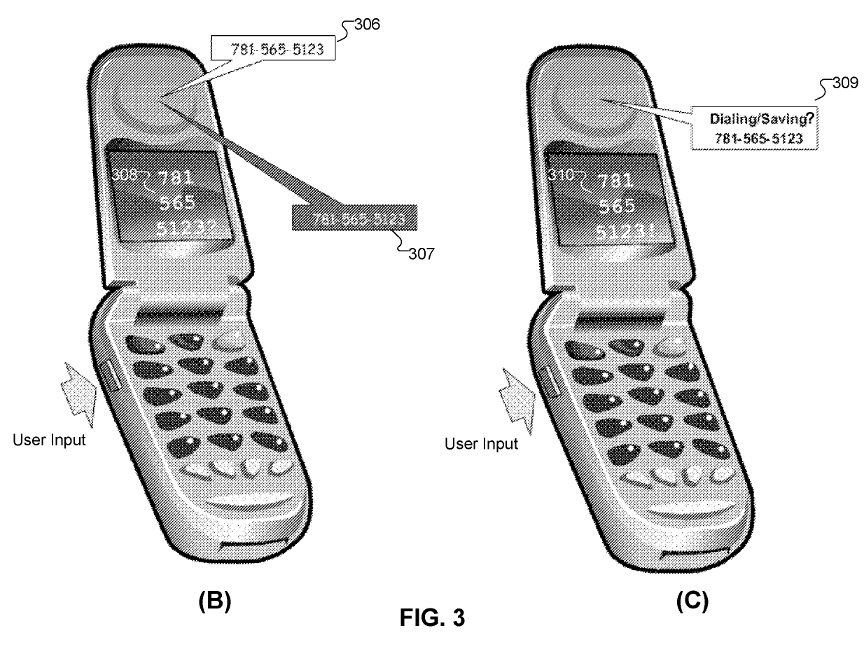

FIG. 1 shows various functional blocks on the side of the user of a mobile device 100 according to one embodiment of the present invention. Generally, audio data 102 from a transmitting party is initially received through an input, such as antenna, from the mobile device network, and processed by microprocessor 104. FIG. 2 shows an operational flow of a real-time extraction of and storing a spoken telephone number from speech, represented by the recent audio data 102, while FIG. 3 pictorially illustrates elements of operation of the various functional blocks of the mobile device 100 of FIG. 1 during the operation shown in FIG. 2.

The microprocessor 104 continuously and automatically buffers a pre-determined amount of the recent audio data 102 on an audio buffer 106 of the mobile device 100, while simultaneously delivering the recent audio data to the user in a form of audio output 108 through a speaker 110. The amount of the audio data instantaneously present in the buffer may be set in different ways, for example by keeping on record only the last N seconds of the phone conversation. This predetermined amount of buffered, during N seconds, data may then be searched, using a speech recognition and extraction application 112, in response to a capture request that may be formatted as one of the user inputs 114, to extract a telephone number from speech represented by the buffered audio data.

Various user inputs 114 may be implemented with the help of a user-input element, which may be represented by, for example, a programmable element 116 or, in some cases, by a hardware button 120 of the user interface (UI) 118 of the mobile device 100. Both the programmable element and the hardware button are specifically configured to accept the user input, in the form of the capture request, to the mobile device, to initiate processing of the recent audio data 102 stored on the recorder 106 in the form of buffered data, to extract the telephone number. In embodiments where the hardware button 120 is used, it is preferably located on the side of the mobile device 100, as shown in FIG. 3, and can be pressed while the user is holding a mobile device to his ear, without interrupting a phone conversation. In some embodiments, one or more user inputs may be derived from a spoken input as interpreted by the processor 104 through speech recognition and extraction process 112. After the extracted telephone number has been audibly provided to the user for confirmation as an audio output 108 and confirmed by the user to be correct (through one of the user inputs 114), an internal memory device 122 permanently stores the extracted number for future use. In some specific embodiments, the user may be additionally prompted to further process the extracted number, for example, by recording and permanently storing in a device memory a name or other auxiliary contact-identifying information associated with the number, or by dialing the number.

Referring to FIGS. 2 and 3, after the recent audio data 102, representing speech that includes the spoken contact information such as a telephone number, has been heard during conversation, step 202, and buffered onto the audio buffer 106, the user sends a capture request input 114, step 204, through the UI 118 to the microprocessor 104. The capture request input 114 may be implemented, for example, by pressing the hardware button 116, preferably located on a side of the mobile device 100 to accommodate a situation when the user may hold the mobile device near to his ear while speaking. Next, at step 206, the microprocessor 104 initiates processing the buffered audio data by searching the buffered data to identify a speech segment containing the spoken contact information.

The search and identification of the speech segment can be carried out using applications well known in the art, such as grammar-based speech end-pointing, for example. Grammar-based end-pointing is generally based on matching the elements of speech with an appropriate grammatical format. In the case of a domestic telephone number, for example, such grammatical format may be pre-determined to limit the telephone number to ten digits, the first three of which designate an area code. In a case of an international phone number, there may be required an additional designator of a country code, which may comprise three digits and precede the ten-digit number. An optional extension to the telephone number, which is known to be defined with appropriate cradling words (such as “extension”), can, therefore, also be readily recognized. It is understood, however, that the invention is not limited to telephone number formats. Specific embodiments of the invention may judiciously utilize various other formats corresponding to different types of well-structured contact information spoken to the user (such as a street address, or an e-mail address, or a URL) to facilitate identification of the speech segment containing the sought-after spoken information.

Referring, again, to FIGS. 2 and 3A, when the speech segment 302 containing the spoken telephone number 304 has been identified, the telephone number 304 is extracted from the audio buffer 106 by the processor 104 through speech recognition and extraction application 112 at step 208. The microprocessor 104 further generates a recognized digital replica 306 of the extracted telephone number at step 210, followed by temporarily saving both the recognized digital replica 306 and the audio corresponding to the identified telephone number 307 in the internal memory device 122 at step 212. After confirming, at step 214, the success of processing the buffered data, including the extraction and recognition process, by, for example, comparing a confidence level of the extraction and recognition with a pre-determined confidence threshold value, the mobile device 100 may announce the results to the user through a user-notifying element of the UI 118, for example by outputting an audio success tone 216 through the speaker 110. Otherwise, if the confidence level falls below the confidence threshold value, the user may be notified with an audio warning tone 218. Alternatively, the user may be notified by activating other user notifier such as a vibrator, configured to generate an alert to reflect the success or failure of the extraction and recognition process.

Embodiments of the invention warrant a minimum level of accuracy and confidence of the telephone-number extraction and recognition, as compared to conventional automatic speech-recognition technology. On one hand, the accuracy of speech-recognition is reciprocally affected by the amount of buffed data containing target information to be captured. To this end, in some embodiments, the buffer length may be determined and pre-set by, for example, having the buffer configured to store only the data received during last N seconds of the telephone conversation. Such determination and pre-setting may be made based upon, for example, statistically averaged amount of time necessary to speak out a telephone number. In such instance, the buffer space (N seconds) may be large enough to make it easy for the user to acquire a just-spoken telephone number, but not as large as to accommodate lots of additional, targetless audio data that might be misconstrued as part of a target utterance. This increases the accuracy of capturing the target information. On the other hand, once N has been preset for the system, by providing his input to the system the user increases the probability of the speech-recognition success because the user input marks the end of and, therefore, unambiguously, uniquely, and completely defines the N-second segment of the received audio data to be searched. Moreover, by optimizing the length N of the buffer 106, the amount of time required to complete the capture and extraction processes is optimized as well because the processor 104 does not have to unnecessarily handle excessive, targetless data.

In addition, to maximize accuracy of recognition and extraction of the spoken telephone number in specific embodiments, the grammar-based speech end-pointing algorithm of the invention may be judiciously designed to statistically incorporate existing history of telephone connections established with a particular mobile device. For example, a list of contacts, saved in memory of the device and containing phone numbers and other information previously used to place a call or extracted from previously received calls, may be incorporated to bias the end-pointing algorithm towards a preferred recognition hypothesis that has higher probability of success without user intervention. As another example, if many of the contacts from the contact list have associated email addresses from a particular domain (such as yahoo.com), the recognition process may be weighed or biased to prefer new contacts that are associated with the same domain.

Following the announcement, to the user, of the results of processing the spoken telephone number 304 from the recent audio data stored on the audio buffer, the mobile device 100 switches into one of two idle states, 220 or 222. These idle states assure that a live mobile phone conversation between the user and the transmitting party continues uninterrupted or, alternatively, voicemail interface remains uncompromised. Idling in the states 220 or 222, the mobile device 100 may be waiting for an appropriate user input, which is instructive of further operation of the mobile device. For example, the user may either request a re-capture 224 of the spoken-phone-number at step 226 (in case the extracted number was not recognized at step 214) or, otherwise, request a confirmation of the recognized phone number at step 228. Either request may be communicated to the mobile device 100 through the user input element of the UI 118 after the live mobile phone conversation or voice mailing has been completed, by either operating a programmable element 116 or pressing a hardware button 120, specifically configured to accept both the re-capture and the confirmation requests.

At step 230 and as shown in FIG. 3B, in response to a user input 114 signifying a request to confirm the extracted phone number, the mobile device 100 plays out, through the speaker 110, the audio corresponding to the identified telephone number 307 identified at step 206 as containing the spoken telephone number 304, followed by synthesized audio corresponding to the recognized digital replica 306 of the spoken telephone number. The recognized digital replica is also displayed as text 308 on the display of the user interface 118. At that point the user makes a decision 232 whether the recognized digital replica 306 is acceptable and correct in that it corresponds to the spoken number 304. The user may confirm the correctness of the phone number extraction by inputting a confirmation input 114, as shown in FIG. 3C, which directs the microprocessor 104 to permanently store the recognized number in internal memory 122 of the mobile device 100 at step 234. Additionally, the user may be prompted at step 236 to process the number further by, for example, recording a contact name or other information associated with the number, and optionally storing such information in combination with the number in the device memory accessible to the user through aural or visual menu, such as “Contact List”. Alternatively, the newly extracted and saved number may be dialed directly, if desired, or both stored—with or without auxiliary associated information—and dialed. These steps 234 and 236 may be accompanied, as shown in FIG. 3C, by audio confirmation 309 and/or displayed text confirmation 310 to the user. On the other hand, if the extraction was found to be incorrect, the user may manually input the number he heard in the played out segment of speech into the permanent memory 122 of the mobile device 100. Otherwise, the operational flow of an embodiment of the invention may terminate if the user does not provide any input after the mobile device entered one of the idle states 220 or 222.

As described, embodiments of the invention allow for the telephone numbers, exchanged by voice over the mobile device, to be saved and reused with nominal intervention by the user. The user's minimal attention is required only to mark the relevant buffered audio data to be searched, initiate further operation of the idling mobile device, and otherwise dispose appropriately of the correctly extracted telephone number. Respectively, as described, the user may provide a capture input initiating the extraction and recognition of the spoken telephone number, either a re-capture or confirmation request recognizing the results of extraction, and a request to either permanently store in the device memory, or dial, or appropriately further deal with the extracted number. In the process of real-time capture of the spoken number the user is, therefore, minimally distracted. The embodiments can be easily implemented as a combination of a computer program product and hardware, compatible with and integrated within existing mass- producible mobile phone devices.

It is understood that operation of the embodiments of the invention requires programmable computer instructions, configuration, and support embodying all or part of the functionality previously described herein with respect to the invention and locally loaded onto the mobile device 100. Those skilled in the art should appreciate that such computer instructions and support can be written in a number of programming languages for use with many computer architectures or operating systems. For example, some embodiments may be implemented as entirely software (e.g., a computer program product) in a procedural programming language (e.g., “C”) or an object oriented programming language (e.g., “C++”). Furthermore, such instructions may be stored in any memory device, such as semiconductor, magnetic, optical or other memory devices, and may be either transmitted to the mobile device 100 using any communications technology (such as optical, infrared, microwave, or other transmission technologies) or embedded in it in a form of a programmable hardware chip with a computer program product fixed in it. It is expected that such a computer program product may be distributed as a removable storage medium with accompanying printed or electronic documentation (e.g., shrink wrapped software), preloaded on a mobile device 100 (e.g., on a mobile device ROM or fixed disk), or distributed from a server or electronic bulletin board over the network (e.g., the Internet or World Wide Web). Of course, some embodiments of the invention may be implemented as a combination of both software and hardware. Still other alternative embodiments of the invention can be implemented as pre-programmed entirely hardware elements.

Although various exemplary embodiments of the invention have been disclosed, it should be apparent to those skilled in the art that various changes and modifications can be made which will achieve some of the advantages of the invention without departing from the true scope of the invention.

What is claimed is:

1. A method for capturing contact information on a mobile device, the method comprising:
receiving a user input at a mobile device to capture contact information contained in recent audio data processed by the mobile device;
based on the received user input, identifying speech in the recent audio data corresponding to the contact information;
in a processor, using speech recognition program to extract the contact information from the identified speech; and
storing the contact information in a mobile device memory storage.

2. A method according to claim 1, wherein storing the contact information includes:
providing the extracted contact information to the user; and
receiving a confirmation input from the user that the contact information has been correctly extracted.

3. A method according to claim 2, wherein the extracted contact information is audibly provided to the user for confirmation.

4. A method according to claim 2, wherein the extracted contact information is visually provided to the user for confirmation.

5. A method according to claim 2, wherein the extracted contact information is provided to the user in response to a confirmation request input from the user.

6. A method according to claim 1, wherein the user input is received from a hardware button on the mobile device.

7. A method according to claim 1, wherein the user input is received from a programmable user input element on the mobile device.

8. A method according to claim 1, wherein extracting the contact information includes outputting to the user a success tone indicating that the contact information has been confidently extracted.

9. A method according to claim 8, wherein the success tone is output when an extraction confidence level exceeds a confidence threshold value.

10. A method according to claim 1, wherein extracting the contact information includes outputting to the user a warning tone indicating that the contact information may not have been successfully extracted.

11. A method according to claim 10, wherein the warning tone is output when an extraction confidence level fails to reach a confidence threshold value.

12. A method according to claim 1, wherein the contact information includes a telephone number.

13. A method according to claim 12, further comprising:
dialing the telephone number in response to a dialing request from the user.

14. A method according to claim 1, wherein using speech recognition includes biasing speech recognition towards a preferred recognition hypothesis based on information previously used to place a call from the mobile device or extracted from previously received calls.

15. A mobile device for wireless networking comprising:
an audio buffer for buffering recent audio data to be processed by the mobile device;
a user input element for receiving a user input from a user to process the recent audio data buffered on the audio buffer; and
a processor connected to the user input element and to the audio buffer, the processor using a speech recognition program for:
i. identifying speech data in the recent audio data that corresponds to spoken contact information,
ii. extracting the spoken contact information from the speech data, and
iii. storing the contact information in a memory storage.

16. A mobile device according to claim 15, further comprising an output module, connected to the processor, for providing a user notification regarding the extracting of the spoken contact information from the recent audio data.

17. A mobile device according to claim 16, wherein the output module includes an audio speaker providing an audio output.

18. A mobile device according to claim 16, wherein the output module includes a vibrator generating a vibrating alert.

19. A mobile device according to claim 15, wherein the user input element is a hardware button on the mobile device.

20. A mobile device according to claim 15, wherein the user input element is a software programmable input element.

21. A mobile device according to claim 15, wherein the user input further is configured to input a user request for confirmation of the contact information.

22. A mobile device according to claim 15, wherein the contact information is a telephone number.

23. A computer program product for capturing contact information on a mobile device, the computer program product comprising a tangible storage medium having a computer readable program code thereon, the computer readable program code including
program code for receiving a user input to capture contact information contained in recent audio data processed by the mobile device;
program code for identifying speech in the recent audio data corresponding to the contact information;
program code for using speech recognition to extract the contact information from the identified speech; and
program code for storing the contact information in a mobile device memory storage.

24. A computer program product according to claim 23, further comprising:
program code for providing the extracted contact information to the user; and
program code for receiving a confirmation input from the user that the contact information has been correctly extracted.

25. A computer program product according to claim 23, wherein the extracted contact information is audibly provided to the user for confirmation.

26. A computer program product according to claim 23, wherein the extracted contact information is visually provided to the user for confirmation.

27. A computer program product according to claim 23, wherein the extracted contact information is provided to the user in response to a confirmation request input from the user.

28. A computer program product according to claim 23, wherein the program code for receiving a user input uses a hardware button on the mobile device.

29. A computer program product according to claim 23, wherein the program code for receiving a user input uses a programmable user input element on the mobile device.

30. A computer program product according to claim 23, wherein the program code for extracting the contact information includes program code for outputting to the user a success tone indicating that the contact information has been confidently extracted.

31. A computer program product according to claim 29, wherein the success tone is output when an extraction confidence level exceeds a confidence threshold value.

32. A computer program product according to claim 23, wherein the program code for extracting the contact information includes program code for outputting to the user a warning tone indicating that the contact information may not have been successfully extracted.

33. A computer program product according to claim 31, wherein the warning tone is output when an extraction confidence level fails to reach a confidence threshold value.

34. A computer program product according to claim 23, wherein the contact information includes a telephone number.

35. A computer program product according to claim 34, further comprising:
program code for dialing the telephone number in response to a dialing request from the user.
